(19) United States
(12) Patent Application Publication
(10) Pub. No.: US 2013/0321738 A1
(43) Pub. Date: Dec. 5, 2013

(54) Backframe and Liquid Crystal Display Device

(71) Applicant: Gang Yu, Shenzhen (CN)

(72) Inventor: Gang Yu, Shenzhen (CN)

(73) Assignee: SHENZHEN CHINA STAR OPTOELECTRONICS TECHNOLOGY CO. LTD., Shenzhen (CN)

(21) Appl. No.: 13/522,498

(22) PCT Filed: Jun. 8, 2012
(86) PCT No.: PCT/CN12/76665

§ 371 Date: Jul. 17, 2012

(30) Foreign Application Priority Data
Jun. 5, 2012 (CN) 201210183075.9

(51) Int. Cl. G02F 1/1333

(52) U.S. Cl. CPC G02F 1/1333
USPC 349/58

(57) ABSTRACT

The present invention discloses a backframe used to carry and support a refractive film of a liquid crystal display device. The backframe includes a backboard, and a reinforced tab and an upright portion. The backboard is incorporated with a plurality of reinforced ribs for supporting and carrying the refractive film. A groove is defined between every two adjacent reinforced ribs. A plurality of reinforced tabs spanned over the groove in an alternative manner so as to support and carry the refractive film. The present invention also discloses a liquid crystal display device. The deformation of the refractive film can be readily avoided by incorporating with reinforced tabs covering grooves on the backboard.

### FIELD OF THE INVENTION

The present invention relates to a technology of liquid crystal display device, and more particularly to a backframe and also a liquid crystal display device.

### BACKGROUND OF THE INVENTION

With continuous development of the technology, the price of a liquid crystal display becomes more and more affordable, and therefore the liquid crystal display is also very popular. During the design a liquid crystal display device, there are a lot of components which need to be reinforced with an additional configuration. However, not all reinforced components can reach an intended and satisfactory result. Referring to FIG. 1, which is an illustrational view of the structure of a backframe. In order to clearly illustrate the backframe configuration, a refractive film 110 is also disclosed. The backframe 100 is a backbone or a vehicle to carry and support all components of the liquid crystal display. It generally includes a backboard 101 on which reinforced structure, a supporting portion 1011 is incorporated. Between every two adjacent supporting portions 1011, a groove 1012 is defined. The supporting portions 1011 are used to support and carry the refractive film 110. Even the backframe 100 has been reinforced, while it is still unfavorable to the true planarity of the refractive film 110.

Referring to FIG. 2 which is an illustrational and cross sectional view of the backframe in which the refractive film is installed. When the refractive film 110 is mounted on the reinforced ribs 1011, the refractive film 110 does not get any solid support on the groove 1012. Once the refractive film 110 is suffered with a certain external pressure, the refractive film 110 is vulnerable to deform or curve in on the portion above the groove 1012. As a result, the liquid crystal display device will experience a dysfunctional or abnormal situation.

It is the purpose of the present invention to provide a technical solution to a backframe and a liquid crystal display in which the backframe can be effectively prevented from any deformation.

In order to resolve the above described issue. the present invention provides a backframe used to carry and support a refractive film of a liquid crystal display device. The backframe includes a backboard, a reinforced tab and an upright portion. The backboard is incorporated with a plurality of reinforced ribs for supporting and carrying, the refractive film. A groove is defined between every two adjacent reinforced ribs. There are a plurality of reinforced tabs spanned over the groove in an alternative manner so as to support and carry the refractive film. The upright portion erects from edges of the backboard and bending toward the refractive film. Sidewalls of the groove are defined with slot in the area adjoining with the reinforced rib so as to receive the reinforced tab. The reinforced tab can be integrally formed with the reinforced ribs or glued thereto.

Wherein the groove has a curve shape, and the joint portion between the sidewall of the groove and the reinforced ribs has a curved transitional portion.

Wherein the reinforced tab has a wedged portion at both ends, and the wedged portions abut against the sidewall of the groove.

In order to resolve the above described issue, the present invention provides a backframe used to carry and support a refractive film of a liquid crystal display device. The backframe includes a backboard and a reinforced tab. The backboard includes a plurality of reinforced ribs for supporting and carrying the refractive film. A groove is defined between every two adjacent reinforced ribs. The reinforced tabs spanned over the groove and support the refractive film.

Wherein sidewalls of the groove are defined with a retaining slot in the area jointing the reinforced ribs to receive the reinforced tab therein.

Wherein the groove has a curve shape, and the joint portion between the sidewall of the groove and the reinforced ribs has a curved transitional portion.

Wherein the reinforced tab has a wedged portion at both ends, and the wedged portions abut against the sidewall of the groove.

Wherein the backboard includes an upright portion erected from edges of the backboard and bending toward the refractive film.

Wherein there are multiple reinforced tabs which are alternatively arranged.

Wherein the reinforced tab is integrally formed with the reinforced ribs.

Wherein the reinforced tab is glued to the reinforced ribs.

In order to resolve the issue encountered by the prior art, the present invention further provides a liquid crystal display device which includes a refractive film and a backframe. The backframe includes a backboard and a reinforced tab. The backboard includes a plurality of reinforced ribs for supporting and carrying the refractive film. A groove is defined between every two adjacent reinforced ribs. The reinforced tabs spanned over the groove and support the refractive film.

Wherein sidewalls of the groove are defined with a retaining slot in the area jointing the reinforced ribs to receive the reinforced tab therein.

Wherein the groove has a curve shape, and the joint portion between the sidewall of the groove and the reinforced ribs has a curved transitional portion.

Wherein the reinforced tab has a wedged portion at both ends, and the wedged portions abut against the sidewall of the groove.

Wherein the backboard includes an upright portion erected from edges of the backboard and bending toward the refractive film.

Wherein the reinforced tab is integrally formed with the reinforced ribs.

Wherein the reinforced tab is integrally formed with the reinforced ribs.

Wherein the reinforced tab is glued to the reinforced ribs.

Wherein the reinforced tab is glued with the refractive film.

From the above disclosure, the reinforced tabs of the backframe and the liquid crystal display device are spanned over the grooves in a way that the refractive film can be readily supported so as to avoid any deformation resulted from poor support. The dysfunctional issues can be successfully resolved, while the cost is comparatively low.

The above described is merely a primary disclosure. In order to readily clarify the technical solution, and therefore implement that technical solution in view of the specification, a detailed description in view of a preferable embodiment in conjunction with accompanied drawings will be given herebelow. By this, other purposes, features and characteristics can be readily appreciated through the detailed description.

### BRIEF DESCRIPTION OF DRAWINGS

FIG. 1 is an illustrational view of a configuration of a prior art backframe;

FIG. 2 is a partial and cross sectional view of a backframe along with a refractive film supported thereon;

FIG. 3 is an illustrational view of a backframe made in accordance with a first embodiment of the present invention;

FIG. 4 is a partial and cross sectional view of the backframe shown in FIG. 3;

FIG. 5 is a partial and cross sectional view of the backframe shown in FIG. 3 along with a refractive film supported thereon;

FIG. 6 is an illustrational view of a backframe made in accordance with a second embodiment of the present invention; and

FIG. 7 is an illustrational view of a back frame made in accordance with a third embodiment of the present invention.

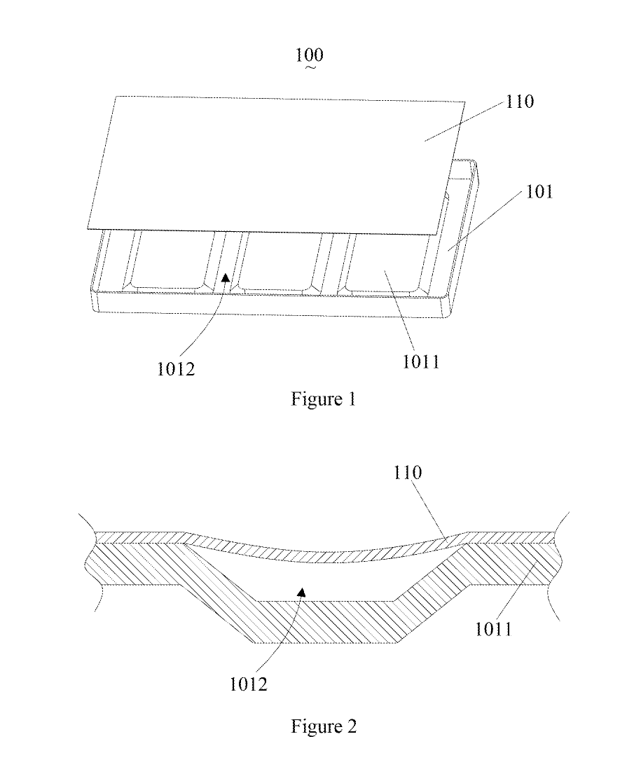

### DETAILED DESCRIPTION OF PREFERRED EMBODIMENTS

In order clearly explain the technology of the embodiment illustrated in the present invention. a brief and concise description will be given along with the accompanied drawings. Apparently, the embodiments illustrated in the drawings are merely some typical embodiments and which can be readily modified by the skilled in the art without any additional laborious efforts so as to transform them into other drawings.

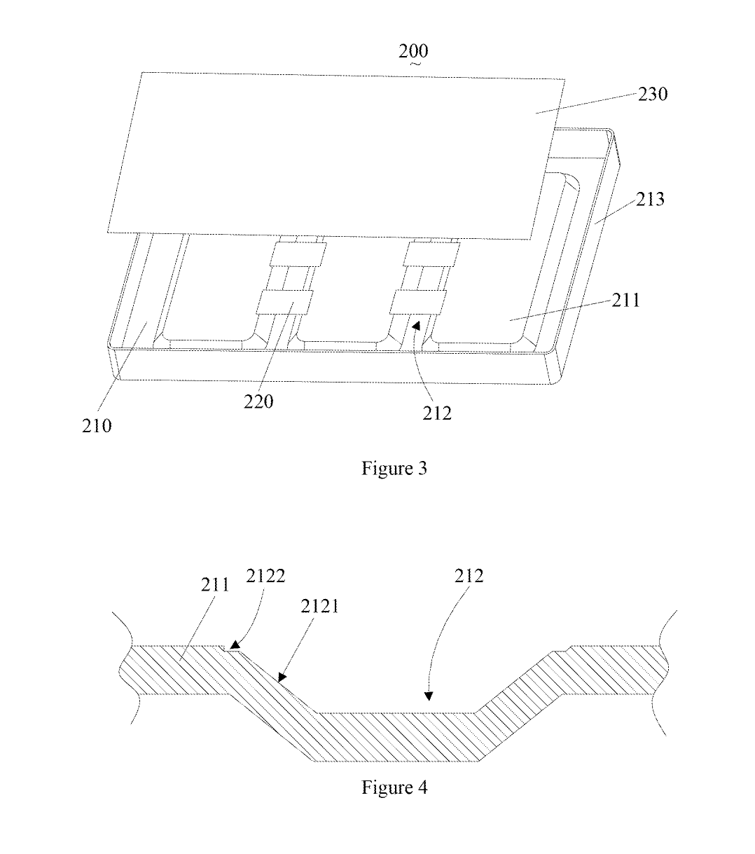

Referring to FIG. 3 and which is and an illustrational view of a backframe made in accordance with a first embodiment of the present invention.

The backframe 200 includes a backboard 210 and at least one reinforced tab 220 so as to support a refractive film 230 thereon. From the drawing, the overall configuration of the back frame can be readily seen. However, for simplicity, the other components which constitute no part of the present invention are omitted.

The backboard 210 is the backbone of the backframe 200. and it has incorporated with a plurality of supporting portions or reinforced ribs 211 supporting the refractive film 230 thereon. In the present invention, the reinforced ribs 211 are formed by stamping on the backboard 210. In other alternatively embodiment, the reinforced ribs 211 can be formed individually and separately, and then attached to the backboard 210 either by screws or by gluing. A groove 212 is defined between every two reinforced ribs 211.

The backboard 210 further includes an upright portion 213 erected from edges of the backboard 210 and bending toward the refractive film 230. The upright portion 213 can be used to position the refractive film 230 such that the refractive film 230 will not move on the surface of the upright portion 213.

The reinforced tabs are spanned over the groove 212 and are used to support the refractive film 230. Substantially, please refer to FIG. 4, which is a partial and cross sectional view of the back frame. The groove 212 has two sidewalls 2121, and each of the sidewalls 2121 is provided with a slot 2122 adjoining to the reinforced rib 211. The slot 2122 is used to receive the reinforced tab 220.

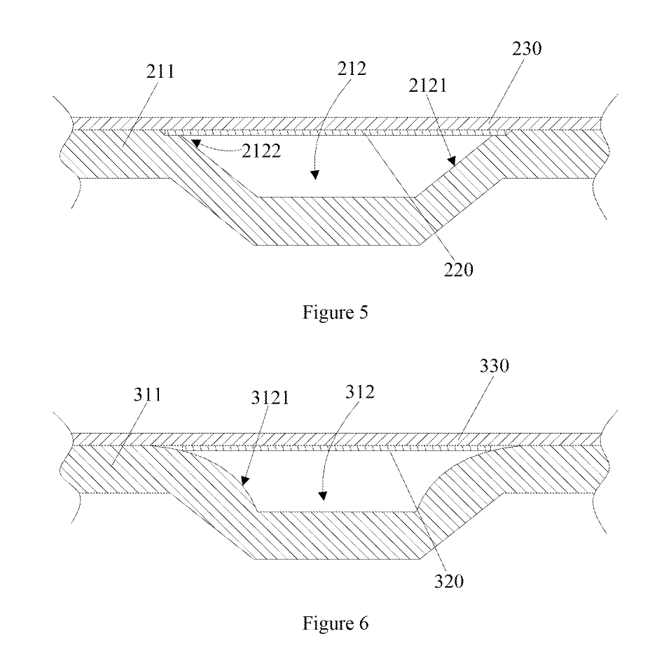

Referring to FIG. 5, which is a partial and cross sectional view of the backframe shown in FIG. 3 along with a refractive film supported thereon. The reinforced tabs 220 are spanned over the groove 212 and properly set into the slots 2122 of the groove 212 with its ends. Accordingly, the reinforced tabs 220 can properly support the refractive tab 230. As the reinforced tabs 220 are limited by the slot 2122 of the groove 212, the reinforced tabs 220 can be readily positioned. Since the refractive film 230 is properly and firmly supported by the reinforced tabs 220, as a result, even the refractive film 230 is exposed to external pressure, the refractive film 230 will not experience any deformation at the area without the supporting of the reinforced ribs 211.

In the present invention, the reinforced tab 220 is embodied with multiple numbers, and they are arranged alternatively with a space or gap therebetween. Even the total surface area of the reinforced tabs 220 could be reduced to a certain degree, while it can be beneficial to the cost-down. In alternative, in other preferable embodiment, each groove 212 can be incorporated with one reinforce tab 220 completely covering the groove 212.

Furthermore, the reinforced tab 220 can be integrally formed with the reinforced rib 211 or it can be glued to the reinforced rib 211 so as to simplify the manufacturing process as well as production time. As a result, the cost is also beneficially reduced.

Referring to FIG. 6 which is an illustrational view of a backframe made in accordance with a second embodiment of the present invention.

The groove 312 has a curved configuration, i.e. the sidewalls 3121 of the groove 312 has a curved transitional portion adjoining a reinforced rib 311. The curved sidewalls 3121 can withhold a reinforced tab 320 vertically such that a refractive film 330 landed thereon can be properly and firmly supported. The curved sidewalls 3121 can be readily formed with simplified manufacturing technology. The cost down can be beneficially achieved. The sidewalls 3121 of the groove 312 and the reinforced rib 311 have a circular transition, and the radius can be readily determined according to the field requirements.

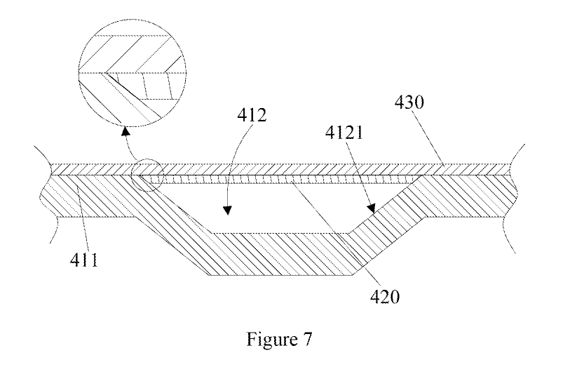

Referring to FIG. 7, which is an illustrational view of a backframe made in accordance with a third embodiment of the present invention.

A groove 412 has an inclined sidewalls 4121, and a reinforced tab 420 has wedged ends having same gradient with the sidewalls 4121 of the groove 412. The wedged ends of the reinforced tab 420 properly abut against the sidewalls 4121 of the groove 412 so as to provide a smooth contact thereof, as clearly shown in enlarged portion circled in FIG. 7. The reinforced tab 420 can readily support the refractive film 430 in the groove 412. As a result, the deformation of the refractive film 430 resulted poor support can be successfully resolved.

In the first, second and third embodiments, the sidewalls of the groove vary depending to different field applications, while in other alternative, those features can be integrally combined together so as to achieve the best result. For example, one of the sidewall is defined with a slot, while the other sidewall can be embodied as a curved slope. In addition, the reinforced tab can also vary according to different field applications. It is believed that any skilled in the art can readily come out with other and similar configuration in light of the disclosure of the present invention, and they should all be covered by the scope of the appended claims.

The present invention further provides a liquid crystal display device in which the back frame disclosed in the above described embodiments can be suitably incorporated. During the assembling of the liquid crystal display device, and in view of the requirements of the manufacturing process, the reinforced tabs can be firstly attached to the refractive film such that the refractive film and the reinforced tab can be readily assembled and positioned in the corrected position.

By way of the foregoing, the present invention provides reinforced tabs spanned over the grooves so as to properly support the refractive film. This provision can readily resolve the dysfunctional issue encountered by the prior art. Any abnormal issues related thereto can be avoided, and a reduced cost can also be benefited.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backframe used to support a refractive film of a liquid crystal display device, wherein the backframe includes:
a backboard incorporated with a plurality of reinforced ribs to support the refractive film, a groove being defined between every two adjacent reinforced ribs;
a plurality of reinforced tab spanned over each of the grooves so as to support the refractive film;
an upright portion erected from edges of the backboard and bending toward the refractive film;
wherein sidewalls of the groove are defined with a retaining slot in the area jointing the reinforced ribs to receive the reinforced tab therein, the reinforced tabs are integrally formed or attached to the reinforced ribs.

2. The backframe as recited in claim I , wherein the groove has a curve shape, and the joint portion between the sidewall of the groove and the reinforced ribs has a curved transitional portion.

3. The backframe as recited in claim I, wherein the reinforced tab has a wedged portion at both ends, and the wedged portions abut against the sidewall of the groove.

4. A backframe used to support a refractive film of a liquid crystal display device, wherein the backframe includes:
a backboard incorporated with a plurality of reinforced ribs to support the refractive film, a groove being defined between every two adjacent reinforced ribs; and
a reinforced tab spanned over the groove to support the refractive film.

5. The backframe as recited in claim 4, wherein sidewalls of the groove are defined with a retaining slot in the area jointing the reinforced ribs to receive the reinforced tab therein.

6. The backframe as recited in claim 4, wherein the groove has a curve shape, and the joint portion between the sidewall of the groove and the reinforced ribs has a curved transitional portion.

7. The backframe as recited in claim 4, wherein the reinforced tab has a wedged portion at both ends, and the wedged portions abut against the sidewall of the groove.

8. The backframe as recited in claim 4, wherein the backboard includes an upright portion erected from edges of the backboard and bending toward the refractive film.

9. The backframe as recited in claim 4, wherein there are multiple reinforced tabs which are alternatively arranged.

10. The backframe as recited in claim 4, wherein the reinforced tab is integrally formed with the reinforced ribs.

11. The backframe as recited in claim 4, wherein the reinforced tab is glued to the reinforced ribs.

12. A liquid crystal display device, including a refractive film, wherein the liquid crystal display device includes a backframe which includes:
a backboard incorporated with a plurality of reinforced ribs to support the refractive film, a groove being. defined between every two adjacent reinforced ribs: and
a reinforced tab spanned over the groove to support the refractive film.

13. The liquid crystal display device as recited in claim 12, wherein sidewalls of the groove are defined with a retaining slot in the area jointing the reinforced ribs to receive the reinforced tab therein.

14. The liquid crystal display as recited in claim 12, wherein the groove has a curve shape, and the joint portion between the sidewall of the groove and the reinforced ribs has a curved transitional portion.

15. The liquid crystal display as recited in claim 12. wherein the reinforced tab has a wedged portion at both ends, and the wedged portions abut against the sidewall of the groove.

16. The liquid crystal display as recited in claim 12, wherein the backboard includes an upright portion erected from edges of the backboard and bending toward the refractive film.

17. The liquid crystal display as recited in claim 12, wherein there are multiple reinforced tabs which are alternatively arranged.

18. The liquid crystal display as recited in claim 12, wherein the reinforced tab is integrally formed with the reinforced ribs.

19. The liquid crystal display as recited in claim 12, wherein the reinforced tab is glued to the reinforced ribs.

20. The liquid crystal display as recited in claim 12, wherein the reinforced tab is glued with the refractive film.
